(19) United States
(12) Patent Application Publication
(10) Pub. No.: US 2018/0050943 A1
(43) Pub. Date: Feb. 22, 2018

(54) BIOREMEDIATION OF RED MUDS

(71) Applicant: Rodinia Resources Pty Ltd, Keilor (AU)

(72) Inventor: William Richards Goodall, Brunswick (AU)

(21) Appl. No.: 15/677,987

(22) Filed: Aug. 15, 2017

(30) Foreign Application Priority Data
Aug. 17, 2016 (AU) 2016903267

(51) Int. Cl. C02F 3/34; B01J 20/12; C02F 3/28

(52) U.S. Cl. CPC C02F 3/341; B09B 3/00; C02F 3/2806; B01J 20/12

(57) ABSTRACT

A process for the bio-neutralisation of red mud, the process including: feeding an alkaline red mud into a bio-digester; feeding biomass including insoluble organic matter into the bio-digester, the biomass supporting a microbial consortium; mediating the digestion of the biomass in the bio-digester or through a train of bio-digesters with microbes in the microbial consortium, to thereby produce organic acid(s) which neutralise alkalinity of the red mud and reduce pH of the red mud; producing a bio-neutralised red mud product having a pH of 10 or less.

### RELATED APPLICATIONS

This application claims priority under 35 U.S.C. 119 to Australian patent application no. 2016903267, filed Aug. 17, 2016, and titled BIOREMEDIATION OF RED MUDS, the entirety of which is incorporated herein by reference.

### FIELD OF THE INVENTION

The invention relates to a process for the bio-neutralisation of red mud.

### BACKGROUND OF THE INVENTION

The waste from conversion of bauxite ore into alumina for production of aluminium is commonly known as red mud. The volume of red mud created depends on the composition of the bauxite ore and usually comprises 1 to 2.5 times the volume of alumina produced. The waste produced is high in alkalinity, exchangeable sodium content, salinity, and can be high in toxic metals. Historically, red mud has maintained high water content. However, within the last decade a move has been made toward dry stacking of red mud, which has greatly reduced the volume for storage.

Red mud dams represent a significant global issue, being a caustic and toxic mine residue. There are close to 3 billion tonnes of red mud stored globally, with around 200Mt being added every year, signifying an ongoing environmental legacy. The large volumes of red mud mean that its environmental management is difficult.

Alumina producers are required to remediate red mud storage facilities upon closure of the refinery. This remediation process requires the storage facilities to be made safe for future generations without contamination of the surrounding environment. However, in many instances, red mud dams are unfenced and maintained within dyked valleys or mined out ore bodies. This poses significant safety risk to people and animals unaware of the wastes corrosivity and precarious stability. It has also led to the percolation of caustic residues into the underground aquifers in local areas. This has resulted in contamination of domestic water wells with elevated sodium and pH readings. The high sodium is speculated to lead to higher incidence of hypertension in local communities using the water.

A number of significant environmental disasters have occurred, including the Akja dam failure in Hungary, 2010. In this case, the red mud broke through retaining walls and the waste flowed into local community, killing 10 people and injuring scores. The negligence of authorities, company management and government officials were largely to blame and there was heavy criticism for poor handling, monitoring, classification & management.

One of the primary issues with red mud is that it is highly alkaline, and thus extremely corrosive. Red Mud typically has a pH in the range of pH 10-13. As such, dams are often unstable for many years after deposition. It has also been found that domestic water wells in the vicinity of the dams have become more alkaline with high sodium concentrations. The highly alkaline waste limits growth or support of plant and animal species. Another significant issue is that red mud maintains a high water content. As such, storage of the large amounts of red mud produced by alumina producers requires a significant amount of land. Often the land used to store the red mud deposits is highly arable which is no longer available for agriculture.

Techniques for the remediation and/or reuse of red mud are subject to a number of barriers to implementation that must be addressed if a commercially viable and sustainable solution is to be developed. The large volumes of red mud for remediation mean that the solutions must be low cost and easily applied. Furthermore, it is desirable that toxic components such as alkalinity and sodicity are mitigated. Present broad groups of remediation options include dewatering, neutralization and capping of the facilities. These are briefly described below.

Dewatering—The high water retention of red mud means that storage is inefficient and includes containment of significant volumes of water. In addition to removing water from the local environment this significantly increases the risks of leakage from the facility or even dam failure, both resulting in contamination of the local waterways and environment. Current best practice in red mud storage is to utilize dry stacking of the material. This process removes significantly more water prior to storage.

Neutralisation—It is generally required for operations to neutralize part or all of stored red mud prior to final closure. This generally involves either sea-water dilution or some form of carbonation.

Capping—Current alumina industry best practice for remediation of red mud storage facilities once they are full or the operation has closed is to apply a soil cap (1-2m depth) on which vegetation may be grown. This removes impacts of alkaline dust emissions and makes the storage facilities safer, but the bulk volume of red mud remains for many years. This can have environmental impacts, including seepage of contaminated water into local water sources. A significant downside of capping is that the land remains unavailable for alternative uses.

There are shortcomings with the remediation options that are presently available. It is an object of the invention to ameliorate at least one of the aforementioned problems of the prior art.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

The inventor has found that treating an alkaline red mud with biomass including a microbial consortium in a bio-digester can result in a bio-neutralised red mud with a lower pH. Accordingly, in one aspect of the invention, there is provided a process for the bio-neutralisation of red mud, the process including:
feeding an alkaline red mud into a bio-digester;
feeding biomass including insoluble organic matter into the bio-digester, the biomass supporting a microbial consortium;
mediating the digestion of the biomass in the bio-digester or through a train of bio-digesters with microbes in the microbial consortium, to thereby produce organic acids which neutralise alkalinity of the red mud and reduce pH of the red mud;
producing a bio-neutralised red mud product having a pH of 10 or less.

In one or more embodiments, the bio-neutralised red mud is easier to handle and store.

The alkaline red mud can have a pH that is above about 12, and in some cases up to about 13. However, the specific pH of the red mud is dependent, in part, on the source of that red mud and whether it has been subject to any form of pre-treatment. It is generally preferred that the bio-neutralised red mud product has a pH that is 9 or less, and more preferably a pH that is 8 or less. Most preferably, the bio-neutralised red mud product has a pH in the range of from about 7 to about 8.

Generally, in an alumina production process, the alkaline red mud is typically produced with a solids content of from about 100 g/L to about 150 g/L. Advantageously, this alkaline red mud may be fed directly from the alumina production process to the treatment process of the present invention.

In other forms, the alkaline red mud may be provided to the treatment process of the present invention from an alkaline red mud storage facility, such as a storage dam. In this case, the alkaline red mud generally has a higher solids content, generally in the range of about 300 g/L to 400 g/L. This is because the alkaline red mud is typically dewatered prior to storage to reduce the storage volume.

For the present invention, it is desirable to provide the alkaline red mud in the form of a slurry or suspension. Preferably the alkaline red mud has a red mud solids content of from about 50 g/L up to about 200 g/L. More preferably, the red mud solids content is from about 100 g/L. Even more preferably, the red mud solids content is up to about 150 g/L. Most preferably, the red mud solids content is from about 100 g/L to about 150 g/L. Given this, in certain embodiments, such as where the alkaline red mud has a higher red mud solids content, the alkaline red mud is diluted to the desired red mud solids content prior to the step of feeding the alkaline red mud into the bio-digester.

In an embodiment, the biomass is fed into the bio-digester in an amount that is at least about 5 w/w % of the dry red mud. Preferably, the biomass is fed into the bio-digester in an amount that is at least about 7 w/w % of the dry red mud. More preferably, the biomass is fed into the bio-digester in an amount that is at least about 10 w/w % of the dry red mud. It is preferred that the biomass is fed into the biodigester in an amount that is up to 20 w/w % of the dry red mud.

As discussed above, the biomass includes insoluble organic matter, such as lignocellulosic biomass. In one or more embodiments, the insoluble organic matter is plant-based organic matter, generally in the form of waste plant matter, such as that from crops. The use of waste plant matter is advantageous as it provides an inexpensive and relatively abundant source of biomass. A wide range of plant-based organic matter may be used. A non-limiting disclosure of such plant-based organic matter includes that derived from a variety of crops, in particular pioneer crops, where such variety of crops include Lucerne hay, sugar cane, bagasse, citrus pulp, coffee husks. The selection of specific plant-based organic matter is primarily dependent on cost and local availability.

Generally, the biomass includes an endemic or naturally present microbial consortium. In certain forms of the invention, this endemic or naturally present microbial consortium is effective to digest the biomass and produce sufficient organic acids to reduce the pH of the red mud. However, the inventors have found that in certain forms of the invention it is advantageous to inoculate the biomass with a soil microbial inoculum including a foreign microbial population. In this context, the term ‘foreign microbial population’ is intended to encompass a microbial population that is not typically endemic to, or naturally present in, the biomass itself. The addition of this foreign microbial population to the microbial consortium can enhance the digestion of biomass and production of organic acids. Thus, in an embodiment, prior to the step of feeding the biomass into the bio-digester, the method further includes incubating the biomass for an incubation time with a soil microbial inoculum including the foreign microbial population. The incubation time is typically from about 1 day to about 18 days. However, shorter incubation times, such as less than 5 days are preferred. More preferably, the incubation time is less than 2 days, and most preferably about 1 day.

In various forms of the invention, the microbial consortium includes a mixture of heterotrophic microorganism and preferably includes an alkaliphilic microbial population. These microorganisms can include heterotrophic bacteria, archaea, and fungi. In one or more embodiments, the microbial consortium includes hydrolytic microorganisms and acidogenic microorganisms. Hydrolytic microorganisms are those that are able to metabolise materials such as cellulose, polysaccharides, proteins, lipids etc. that are present in the organic matter and produce, as a metabolic product, monomers such as monosaccharides, amino acids, and fatty acids. Acidogenic microorganisms are able to break down these metabolic products to produce short chain organic acids. A wide range of microorganism may be used. However, it is preferred that the microbial consortium include at least one population of bacteria selected from the phylums of Bacteroidetes, Firmicutes, or Actinobacteria. More preferably, the microbial consortium includes at least one population of bacteria selected from the order Lactobacillales; or of the family Acetobacteraceae or Enterobacteriaceae. Most preferably, the microbial consortium includes at least one population of bacteria selected from the genus Alkalibacter.

The term ‘organic acid’ is generally intended to encompass any organic acids that are produced as metabolic products of the digestion process (e.g. amino acids, fatty acids, and short-chain organic acids such as C₁-C₆ carboxylic acids). However, in a preferred embodiment, the organic acids include at least one of lactic acid and acetic acid. Accordingly, in this embodiment the microbial consortium includes lactic acid generating microorganisms and/or acetic acid generating microorganisms.

In a preferred form of the invention, the microbial consortium additionally includes a population of bacteria which are able to produce sulfuric acid.

In an embodiment, the process additionally includes providing a nutrient amendment to the microbial consortium. The purpose of the nutrient amendment is to enhance or promote the growth of the microbial consortium. The nutrient amendment may be in the form of a soluble organic nutrient amendment, and/or a soluble or insoluble mineral nutrient amendment. The type and nature of the nutrient amendment may vary depending on the specific environment during growth of the microbial consortium, such as into the biodigester(s). Generally, the nutrient amendment provides a source of food (such as organic compounds to meet the BOD of the microbial consortium) and nutrients for use by the microbial consortium to regulate metabolic process (such as the generation of organic acids) as well as to promote growth. Typically, the nutrient amendment is added in an amount of about 1 to about 15 v/v % (based on the volume of red mud to be treated). Preferably, the nutrient amendment is added in an amount of 2 to 12 v/v%. More preferably, the nutrient amendment is added in an amount of 5 to 10 v/v%.

The nature of the nutrient amendment is, in certain embodiments, dependent on the type of insoluble organic matter that is used. Some forms of insoluble organic matter may be high in carbohydrates, and therefore provide an adequate supply of organic compounds to meet the BOD. However, this insoluble organic matter may be deficient in particular trace minerals. In this case, the nutrient amendment will include a relatively higher proportion of minerals to meet this deficiency.

In another form, certain organic compounds and/or minerals may be added to promote the growth of one or more populations of microbial organisms over other populations of microbial organisms. For example, some forms of insoluble organic matter may naturally give rise to microbial consortiums that include a significant population of acidogenic organisms which are reliant on the metabolic product of heterotrophic organisms. In this way the population of heterotrophic organisms and the rate at which the heterotrophic organisms generate metabolites that can be consumed by the acidogenic organisms limits the population and rate at which the acidogenic generate organic acids. In this case, the nutrient amendment may be tailored to encourage the growth of the heterotrophic organism population, and thus minimise the rate limiting effect of the heterotrophic organisms on the production of organic acids.

The nutrient amendment may be: pre-mixed with the biomass prior to, or during, the step of feeding the biomass to the reactor; fed directly into the bio-reactor with the biomass, or into one or more bio-reactors in the train of bio-reactors; added during the step of incubating the biomass with a soil microbial inoculum; or a combination thereof. That is in one form, prior to the step of feeding the biomass into the bio-digester, the method further includes providing the nutrient amendment to the biomass, and preferably incubating the biomass with the nutrient amendment to promote the growth of an endemic microbial consortium. This incubation step may be conducted in the presence of the soil microbial inoculum (if included), as discussed previously in which case the nutrient amendment also assists to promote growth of foreign microbial population.

It is preferred that the nutrient amendment includes at least soluble carbohydrates and/or nitrogenous compounds and/or phosphate and/or amounts of inorganic minerals. Ideally the nutrient amendment is sourced as a waste byproduct from processing plant matter, such as a food processing plant. Again, this provides a relatively inexpensive and abundant source of nutrients, and has the added benefit of remediating a further waste stream that may otherwise contaminate the environment.

Although a wide range of nutrient amendments is contemplated, in one specific example the nutrient amendment is dunder (also known as vinasse in Australia). Dunder is the final waste product from distillation of rum. It contains high levels of residual organics, potassium, sulfur and nitrogen and has very high Biological Oxygen Demand (BOD). Advantageously, dunder is acidic with pH of 4.5.

The process may further include the addition of a mineral amendment either to the alkaline red mud or the biomass prior to feeding these streams into the bio-digester, or as a separate feed stream to the bio-digester or one or more bio-digesters in the train of bio-digesters. The skilled addressee will appreciate that a wide range of mineral amendments are possible. However, the inventor has found that the addition of gypsum is particularly beneficial. Gypsum includes calcium which can mitigate issues associated with the high degree of sodicity of the red mud. Gypsum also promotes the growth of preferred microorganisms in the microbial consortium, and assists in flocculating the bio-neutralised red mud product which is advantageous in embodiments in which the bio-neutralised red mud product is subjected to a downstream dewatering treatment step. The amount of the further nutrient amendments that are required are dependent on the process and may be reactionary for example, to improve growth of the microbial consortium or acid generation etc. Typically, the mineral amendment (particularly in the case of gypsum) will be added at up to about 10% w/w based on the dry weight of the red mud; more preferably up to about 8 w/w %, even more preferably up to about 6 w/w %; and most preferably, up to about 5 wt %.

In one embodiment, the process is a continuous process, wherein the step of feeding the alkaline red mud into the bio-digester is a step of continuously feeding the alkaline red mud into the bio-digester; the step of feeding biomass into the bio-digester is a step of continuously feeding the biomass into the bio-digester; and the step of withdrawing the neutralised red mud product from the bio-digester or the train of bio-digesters is a step of continuously withdrawing the neutralised red mud product from the bio-digester or train of bio-digesters.

A range of different continuous processes are contemplated.

In one form, the bio-digester or train of bio-digesters is stirred tank bio-digester or a train of stirred tank bio-digesters. Typically, the stirred tank bio-digester or a train of stirred tank bio-digesters are operated to provide a red mud residence time of at least about 5 days. Preferably the residence time is at least 6 days. More preferably, the residence time is at least 7 days. While there is no specific upper limit on the residence time, it is preferred that the residence time is less than 10 days, such as 9 days, or 8 days.

In another form, the bio-digester or train of bio-digesters is a flow through cell bio-digester or a train of flow through cell bio-digesters. Typically, the flow through cell bio-digester or a train of flow through cell bio-digesters are operated to provide a red mud residence time of at least 10 days. Preferably the residence time is at least 12 days. More preferably, the residence time is at least 14 days. While there is no specific upper limit on the residence time, it is preferred that the residence time is less than 20 days, such as 18 days, or 16 days.

In still alternate forms, the process includes a train of bio-digesters including at least one stirred tank bio-reactor and at least one flow through cell bio-digester. In such cases, the residence time of the red mud in the train of bio-digesters will typically be from at least 5 days, and preferably less than 20 days.

Further aspects of the present invention and further embodiments of the aspects described in the preceding paragraphs will become apparent from the following description, given by way of example and with reference to the accompanying drawings.

In another aspect of the invention, there is provided a bio-neutralised red mud produced according to the method described above.

### BRIEF DESCRIPTION OF THE DRAWINGS

FIG. 1 provides an illustrative embodiment of a process for the treatment of red mud according to the present invention using a train of stirred-tank bio-digesters.

FIG. 2 provides an illustrative embodiment of a process for the treatment of red mud according to the present invention using two flow-through cell bio-digesters.

FIG. 3 provides an illustrative embodiment of a flow-through cell bio-digester.

FIG. 4 shows redox potential after 7 days of incubation under room temperature in amended red mud derived from the Alpart (Caribbean Red Mud 1—CRM1) red mud dam (A) and the Jamalco (Caribbean Red Mud 2—CRM2) red mud dam (B) which were incubated with 250 ml (100%) growth media (GM).

FIG. 5 shows change of pH in the paste solution of Caribbean Red Mud 1 amended with 1, 5 and 10% (w/w) lucerne hay and watered with 250 ml (100%) growth medium (GM), respectively, in a preliminary test under room temperature.

FIG. 6 shows changes of pH in paste solution of Caribbean Red Mud 1 amended with Lucerne hay and sugarcane mulch, which were watered with 125 (50%) and 250 ml (100%) growth medium (GM) in a preliminary test over a period of 7 days. The values were means of 2 replicates with standard deviation (bars).

FIG. 7 shows levels of Na+ in pore water of amended Caribbean Red Mud 1 (A) and Caribbean Red Mud 2 (B) red mud over a period of 14 days in an incubation experiment. The values were means of three replicates with bars representing their standard deviations.

FIG. 8 shows background microbial properties: species diversity and richness in samples of garden soil and red mud (Caribbean Red Mud 1 and Caribbean Red Mud 2 red mud) incubated with the addition of de-ionized (DI) water for 24 hours under room temperature.

FIG. 9 shows background microbial properties: species diversity and richness in samples of garden soil and organic amendments (Lucerne hay and sugarcane mulch) with soil inoculum preincubated for 24 hours. The garden soil was used to prepare soil microbe inoculum suspension. The organic amendments were used in the red mud bioremediation experiment.

FIG. 10 shows a preliminary test of cation exchange capacity (CEC) in Caribbean Red Mud 1 (A) and Caribbean Red Mud 2 (B) red mud amendment treatments at the end of 14 days of incubation. No pretreatment was used to wash off the soluble Na present in the red mud.

FIG. 11 shows change of pH in paste solution of Caribbean Red Mud 1 (A) and Caribbean Red Mud 2 (B) red mud which were amended with soluble organic compounds (e.g., glucose and molasses) and solid organic matter (e.g., lucerne hay and sugarcane mulch), respectively. The suspensions were inoculated with soil inoculum and incubated under room temperature without shaking.

FIG. 12 shows levels of low molecular weight organic acids in paste solutions of Caribbean Red Mud 1 (A) and Caribbean Red Mud 2 (B) red mud in amendment treatments in a 14-day incubation experiment. The samples were taken on Day 1 after treatment. Value bars for each parameter on the X-axis, shown from left to right represent (i) lactic acid, (ii) acetic acid, and (iii) oxalic acid.

FIG. 13 shows dynamics of alpha diversity of microbial community in Caribbean Red Mud 1 and Caribbean Red Mud 2 in response to amendments

### DETAILED DESCRIPTION OF THE EMBODIMENTS

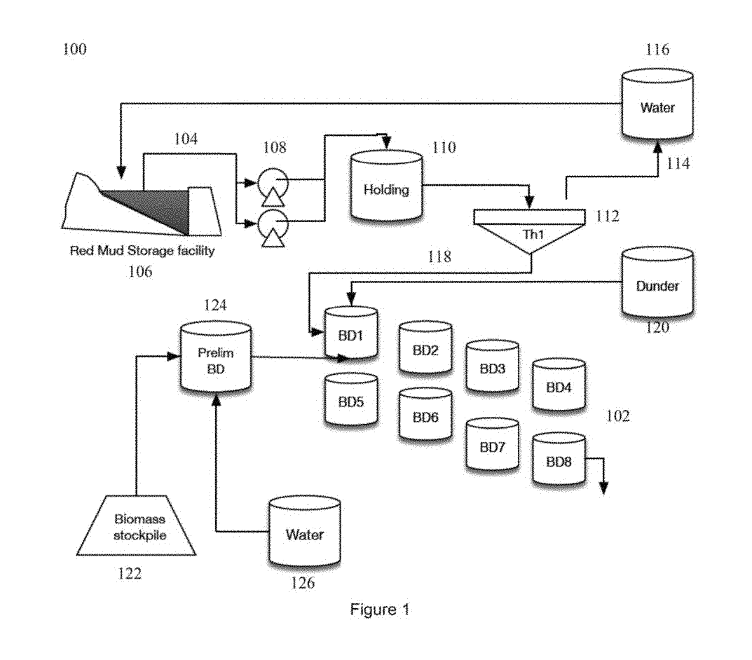

FIG. 1 provides an illustrative embodiment of a process 100 for the treatment of red mud according to the present invention using a train of stirred-tank bio-digesters 102 (each bio-digester designated as BD1 to BD8).

The use of stirred-tank bio-digesters 102 allows the conditions for neutralisation of the red mud to be carefully managed through precise addition of nutrients and better control of mixing and thus provides fast reaction kinetics (which corresponds with a lower residence time digestion). The use of stirred-tank bio-digesters also permits aerobic conditions to be easily managed or maintained if required.

A primary consideration with the use of stirred tank biodigesters 102 is that the practical maximum throughput for the bioneutralisation is restricted by the maximum volume of the tanks and required number of tanks in the process train. For the stirred tank biodigesters 102 used in this application the practical maximum volume is between 2000 m³ and 4000 m³. While it is beneficial to utilise a tank train to allow targeted addition of nutrients it is also important that this train is kept manageable.

In the embodiment illustrated in FIG. 1, the process 100 includes pumping a slurried feed of red mud 104 (having a pH of typically around 12-13) from a red mud storage facility 106 using pumps 108 to a holding tank 110. The red mud may be subject to a pre-treatment step (not shown) in the holding tank 110. Pre-treatment may include the direct addition of dunder.

Dunder is considered a problematic waste product and discharge to local waterways has been linked to a number of fish kill events. The current major use of Dunder is for irrigation of local sugar cane but this is predominantly for water recovery rather than any significant benefit to growth. However, dunder is a useful additive to the bioneutralisation process for neutralization.

TABLE 1
A summary of the typical composition of Jamaican dunder:

| Composition | Concentration. |
|---|---|
| Total Solids | 9.60% by wt |
| SiO2 | 0.076% by wt |
| Ca | 0.29% by wt |
| Mg | 0.11% by wt |
| K | 0.74% by wt |
| Cl | 0.37% by wt |
| SO4 | 0.43% by wt |
| N | 0.12% by wt |
| BOD | 22,000-28,700 ppm |
| pH | 4.5 |

The addition of dunder is advantageous as the dunder not only provides a source of nutrients for the microbial consortium during the subsequent digestion process in the train of biodigesters 102, but dunder is acidic and therefore will neutralise some of the alkalinity of the red mud and promote a more favourable growth environment for at least some of the microbial populations in the consortium. Alternatively or additionally other pre-treatment steps may be carried out in the holding tank 110, such as addition of further nutrients or flocculants. Gypsum is an additive that provides a number of advantages to the process. Gypsum can be used to rapidly lower the ratio of soluble Na:Ca concentrations and thus salinity/sodicity effects and galvanise the stability of aggregates. Further, as previously discussed, gypsum also acts as a flocculant to assist with dewatering; and additionally, promotes microbial activity.

In this embodiment, the red mud is transferred from the holding tank 110 to a thickener 112 prior to the digestion process. In this embodiment, the red mud is pre-treated with gypsum in the holding tank 110 to promote aggregation of fine grained red mud particles and stabilise sodium cations.

In the thickener 112, gravity separation of the solids and the liquids results in a nominally clarified liquor 114 that is stored and/or treated in water holding tank 116, before being recycled to the red mud storage facility 106. The solids stream (typically with solids concentration in the range of 30-40 wt %) is removed in an underflow 118 from the thickener 112 and fed into the first tank BD1 in the train of stirred tank bio-digesters 102. Dunder from dunder storage tank 120 and pre-treated biomass are also fed into the first tank BD1 in the train of stirred tank bio-digesters 102. Biomass is generally added to the process at a rate of 10% w/w to dry red mud.

The primary reagent for the process is biomass including insoluble organic material, which may be in the form of plant-based waste sourced from local industries. A suitable biomass source is sugar cane ‘trash’, which is the green leaf waste from harvesting of sugar cane. However, a variety of other forms of biomass may be used. Prior to feeding the biomass into bio-reactor BD1, the biomass is collected from a biomass composting stockpile 122 and loaded in a feed bin and conveyer to a preliminary biomass digester 124 where it is agitated with at least water 126 and preferably growth media, nutrients and pre-cultured bacterial populations (such as in the form of a soil microbial inoculum including a foreign microbial population) to promote initial digestion and growth of the microbial consortium. In the biomass digester 124, organic acid will be produced in a controlled environment which will reduce stress on bacterial populations due to subsequent mixing with the red mud in bio-digester tank BD1. The bacterial populations utilised are endemic microbial populations driven by decomposition of biomass and augmented with cultured populations isolated from these natural populations.

In tank BD1, the red mud, biomass, and dunder are mixed together for biodigestion producing organic acids to neutralise the red mud and lower its pH. After initial mixing and treatment, the mixture is fed through additional bio-digesters B2 to B8. The mixture may be fed through each of these bio-digesters in a sequential manner, or the mixture may be split into parallel treatment streams. Organic acids, nutrient amendments and pre-cultured populations of bacteria can be progressively added into each of bio-digesters BD1 to BD8 as required. The residence time in each of bio-digesters BD1 to BD8 depends on the volume of the bio-digester and the specific reaction scheme that is adopted. Typically, for a stirred tank bio-digester system, the required residence time for the digestion process (that is the sum of the residence times of each of the bio-digesters in the train) is about 7 days to reduce the pH to a value of around 7-8.

At completion of digestion the neutralised material may be dewatered for further processing and/or storage.

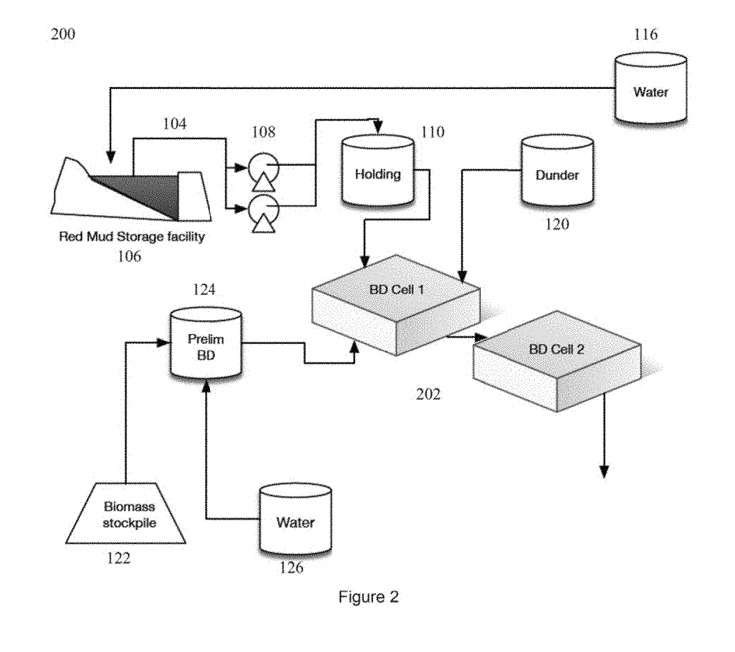

FIG. 2 provides an illustrative embodiment of a process 100 for the treatment of red mud according to the present invention using a train of flow-through cell bio-digesters 202. The embodiment of FIG. 2 includes a number of similarities with that illustrated in FIG. 1, and as such the skilled addressee will appreciate that the like numerals of FIG. 2 represent similar treatment or process components as discussed in relation to FIG. 1.

The key difference between the embodiment shown in FIGS. 1 and 2 is that the stirred-tank bio-digester train 102 has been replaced with two flow-through cell bio-digesters 202 in series (denoted as BD cell 1 and BD cell 2 respectively).

The primary benefits of this circuit configuration are that the capital requirement is very low when compared to stirred-tanks and the throughput is only constrained by the available land area. In terms of construction, the cell biodigester is similar to a lined dam. As such, construction costs are relatively low, and future scale up of the system will not require significant cost. In addition, a cell biodigester does not require a large numbers of pumps and tank agitators; and as such has a low operating cost, and is simple to operate and maintain. However, a cell biodigester has a large footprint and has slower reaction kinetics than stirred-tanks.

The red mud is pumped directly from the red mud storage dam 106 to the biodigester without need for dewatering. Hence, the process can be conducted without thickener 112 as illustrated in FIG. 1. This increases the volume requirements for the biodigester but allows better flow characteristics and more complete treatment of contained water.

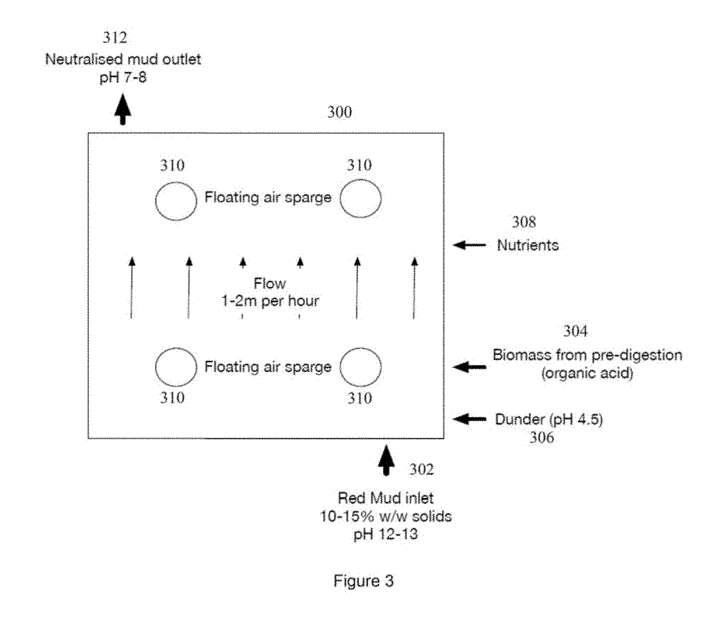

FIG. 3 provides an illustration of one embodiment of a cell bio-digester 300 such as BD cell 1 or BD cell 2.

The process involves preliminary addition of pre-digested biomass and dunder to the red mud material at the cell inlets 302 and 304. The mixed material then flows at a rate of 1-2 metres per hour through the cell with periodic addition of dunder and nutrients via inlets 306 and 308 as required. Flow is maintained using gravity and floating air spargers 310, which also act to maintain sufficient aeration for oxidation of alcohols to organic acids in the biodigestion process. The neutralised red mud product can then be taken off from outlet 312.

The initial target residence time for biofermentation to reduce pH of Red Mud from pH 12-13 to pH 7-8 is 14 days in the cell biodigester.

### Experimental Results

### Red Mud Samples

Red mud is the major chemical wastes formed as a resulting of alumina (Al₂O₃) extraction from bauxite (Bayer process), during which, Al₂O₃ is produced based on the reaction with sodium hydroxide under heat and pressure. The chemical and mineralogical composition of the residue as well as its particle size distribution is highly variable because of differences in bauxite grades and Bayer process operating conditions. In general, this residue is a highly alkaline (pH 10-13) mixture consisting of fine textured particles (80% particles<8 μm). The major mineral constituents are crystalline hematite (Fe₂O₃), boehmite (y-AlOOH), quartz (SiO₂), sodalite (Na₄Al₃Si₃O₁₂Cl) and gypsum (CaSO₄.2H₂O), with a minor presence of calcite (CaCO₃), whewellite (CaC₂O₄.H₂O) and gibbsite Al(OH)₃ The major sources of alkalinity in the residues are from NaOH, Na₂CO₃, NaHCO₃ and NaAlO₂ in the process liquor and the potential alkalinity present as sodium-aluminium-silicate minerals (sodalite).

Thirty-three (33) samples were collected from 11 sites at the Alpart waste storage facilities and 24 samples from 11 sites from the Jamalco storage facilities. Samples were collected from the upper 2-3 m of each dam. The red mud samples from Alpart (Caribbean Red Mud 1) and Jamalco (Caribbean Red Mud 2) dams were rich in clay mineral (Al/Fe oxides) and of high salinity, sodicity, alkalinity, and pH.

Mineralogical analysis was undertaken by X-Ray Diffraction (XRD) at United Mineral Services:

TABLE 2
Caribbean Red Mud 1 (CRM1) minerology

| Mineral | Indicative Formula* | Alpart | ±Error |
|---|---|---|---|
| Amorphous | Undefined | 18.9 | 1.5 |
| Al-Hematite | α-(Fe,Al)₂O₃ | 40.3 | 0.5 |
| Calcite | CaCO₃ | 14.2 | 0.4 |
| Boehmite | γ-AlO(OH) | 2.4 | 0.3 |
| Gibbsite | Al(OH)₃ | 5.6 | 0.5 |
| Al-Goethite | α-(Fe,Al)O•OH | 10.2 | 0.4 |
| Rutile | TiO₂ | 0.6 | 0.3 |
| Anatase | TiO₂ | 0.8 | 0.2 |
| Zircon | ZrSiO₄ | 0.7 | 0.2 |
| Quartz | SiO₂ | 0.4 | 0.2 |
| Cancrinite | Na₆Ca₂Al₆Si₆O₂₄(CO₃)₂ | 5.9 | 0.6 |
| TOTAL | | 100.0 | |

The results from CRM1 indicated an average pH of 11.1 and moisture content of 41.2% w/v.

TABLE 3
Caribbean Red Mud 2 (CRM2) minerology

| Mineral | Indicative Formula* | Jamaica | Error |
|---|---|---|---|
| Amorphous | Undefined | 25.2 | 1.5 |
| Al-Hematite | α-(Fe,Al)₂O₃ | 35.7 | 0.5 |
| Calcite | CaCO₃ | 9.8 | 0.4 |
| Boehmite | γ-AlO(OH) | 2.7 | 0.3 |
| Gibbsite | Al(OH)₃ | 8.4 | 0.5 |
| Al-Goethite | α-(Fe,Al)O•OH | 10.7 | 0.4 |
| Rutile | TiO₂ | 0.8 | 0.3 |
| Anatase | TiO₂ | 3.4 | 0.2 |
| Zircon | ZrSiO₄ | 0.4 | 0.2 |
| Quartz | SiO₂ | 0.6 | 0.2 |
| Cancrinite | Na₆Ca₂Al₆Si₆O₂₄(CO₃)₂ | 2.3 | 0.6 |
| TOTAL | | 100.0 | |

The results from CRM2 indicated an average pH of 12.3 and moisture content of 41.2% w/v.

### 2 Bio-Neutralisation Experiments

Growth Medium and Organic Amendments

Growth medium was prepared as shown in Table 4 below. The growth medium for these experiments include glucose (carbohydrate energy source), peptone (nitrogen for amino acids), yeast extract (vitamins and minerals), KH₂PO₄ (phosphate for ribonucleic acids) and CaCO₃ (buffer).

TABLE 4
Chemical composition and general
properties of growth medium (GM).

| | Concentration |
|---|---|
| Chemical composition | (g/L) |
| Peptone | 5 |
| Yeast extract | 0.5 |
| Calcium carbonate | 0.5 |
| Glucose | 2.5 |
| KH₂PO₄ | 4 |

Organic matter used in the experiments included Lucerne hay (LH) and sugarcane mulch (SC). The organic matter was oven dried for 72 hours at the temperature of 65° C. ground to pass through 1 mm sieve and to achieve uniform mixing with the red mud. Other amendments applied to the red mud included the addition of molasses (MS) (Red Seal, Qld) (the natural raw product left after sugarcane crushing, rich in essential minerals, vitamins and trace elements), and D-glucose (GC) (C₆H₁₂O₆, analytical grade, Chemical Supply, Australia).

TABLE 5
Properties of soluble organic compounds (glucose, molasses)
and solid organic matter (Lucerne hay, sugarcane mulch):
total organic carbon (TOC), total nitrogen (TN), C:N ratio,
soluble carbohydrates and starch. The values were means of
three replicates with standard deviation in the parentheses.

| | | | | Soluble | |
|---|---|---|---|---|---|
| | | | | carbo- | |
| Types | TOC | TN | C:N | hydrates | Starch |
| of OA | (%) | (%) | ratio | (mg/g) | (mg/g) |
| Glucose | 40.0(0.1) | nd | nd | 1000.0 | 0 |
| Molasses | nd | nd | nd | 446.9(24.8) | 13.5(1.2) |
| Lucerne | 43.1(0.1) | 2.4(0.02) | 18.0(0.1) | 14.4(5.7) | 17.6(1.3) |
| hay | | | | | |
| Sugar- | 35.9(0.1) | 0.6(0.01) | 58.5(0.7) | 12.6(4.0) | 20.3 |
| cane | | | | | (4.1) |
| mulch | | | | | |

Soil Inoculum Preparation and Pre-Incubation of Organic Amendments to Build Up Microbial Abundance

Garden soils were sampled from vegetated sites for the preparation of microbial inoculum. The soil samples were pre-incubated in room temperature for 24 hours and microbial growth was verified by using DNA contents.

The soil inoculum was extracted with sterilized TDI water at the ratio of 1:3 (w/w). DNA of the soil inoculum was extracted with the extraction kit of PowerSoil®.

Preliminary Experiment

The preliminary experiment aimed to provide key information for establishing and optimizing treatment factors to be adopted in the bioremediation experiment and refine experimental protocols. The experiment was conducted over a 2 week period to investigate:
initial responses in pH changes to organic amendments which were pre-incubated with soil microbial inoculum;
short-term effects of rates of organic amendments on pH dynamics in the red mud bio-reaction system;
initial effects of different types of organic amendments on pH dynamics in the amended red mud;
effects of solution (growth medium) and solid (red mud) ratios on pH dynamics in the amended red mud.

Treatment details in the preliminary experiment are summarized in Table 5, which included control (red mud added with growth medium without organic matter), Lucerne hay (1, 5, 10% w/w), sugarcane mulch (10% w/w) and growth medium (vol (ml)/wt (g)—50%, 100%). The soil inoculum was added into the organic amendments at the ratio of 10% (w/w) which were pre-incubated aerobically at room temperature before use to boost microbial abundance. The treatments were incubated in 500 ml polystyrene containers covered loosely with caps, which were shaken on an orbital shaker at the rate of 120 rpm. At day 1, 2, 3, 5 and 7 after commencing treatment, approximate 25 g fresh samples were subsampled for pH measurement.

TABLE 5
Treatment details in the preliminary experiment using
Caribbean Red Mud 1 red mud and organic amendments.

| | | | | | Addition | Growth |
|---|---|---|---|---|---|---|
| | | | Red | | rate | medium added |
| ID | Treatment | | mud | Organic matter | (g/100 g | (ml/100 g |
| No. | name | | (g) | added | red mud) | red mud) |
| 1 | Control + | 50% GM | 100 | NA | 0 | 50 |
| 2 | 10% LH + | 50% GM | 100 | Lucerne hay (LH) | 10 | 50 |
| 3 | 10% SC + | 50% GM | 100 | Sugarcane mulch (SC) | 10 | 50 |
| 4 | Control + | 100% GM | 100 | NA | 0 | 100 |
| 5 | 1% LH + | 100% GM | 100 | Lucerne hay (LH) | 1 | 100 |
| 6 | 5% LH + | 100% GM | 100 | Lucerne hay (LH) | 5 | 100 |
| 7 | 10% LH + | 100% GM | 100 | Lucerne hay (LH) | 10 | 100 |
| 8 | 10% SC + | 100% GM | 100 | Sugarcane mulch (SC) | 10 | 100 |

Note:
as a preliminary test, each treatment was only duplicated.

Preliminary Experiment on Addition Rates of Organic Matter and Growth Medium

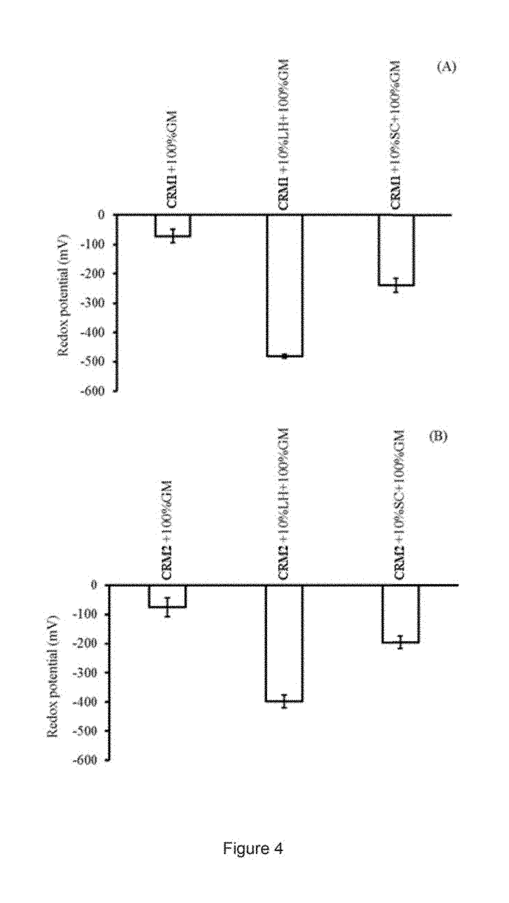

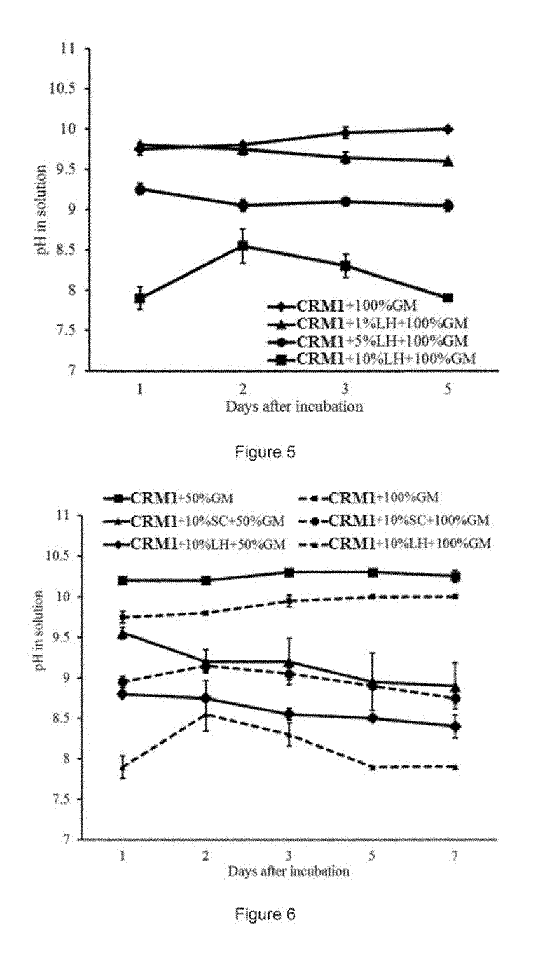

The following major findings were obtained in the preliminary experiment:
It was observed that adding the LH and SC significantly changed the texture, based on visual assessment, compared to the fine mud of the red mud samples without adding any solid organic matter.
The LH amended red mud had more negative redox potential than the unamended Caribbean Red Mud 2, and the Caribbean Red Mud 2 amended with SC (FIG. 4). This suggest that the redox condition in the LH-amended red mud (for both Caribbean Red Mud 1 and Caribbean Red Mud 2) was more reducing than the SC-amendments, and much more reducing than the red mud without the organic amendments (FIG. 4).
The GM solution itself had some neutralizing effects, as the GM was acidic with a pH of 5.24, thus causing some (but not significant) direct neutralization of the high alkalinity (FIG. 5). The pH was 6.3-6.8 in the preincubated organic matter with garden soil microbial inoculum.
In the Caribbean Red Mud 1 amended with the LH, the magnitude of pH reduction increased with an increase in the LH addition rate from 1 to 10% w/w (FIG. 5). The red mud exhibited a pH recovery response to the neutralizing effects of the LH amendment, with the initial large decline in pH to about 8.0, but which recovered to about 8.5 on day 2 and finally resettled back to about 8.0 on day 5. The pH in the 10% LH amended red mud decreased by 2.5-3 units to about 8.5 on day 5 after incubation, compared to the 1.2-1.5 unit reduction in the 5% LH treatment (FIG. 5). The pH in the 5% LH amended Caribbean Red Mud 1 persisted at about 9.0 by day 5.
The LH produced a significantly larger pH reduction in the Caribbean Red Mud 1, than the SC, regardless of the solid-solution ratio (FIG. 6). The growth medium alone had some neutralizing effects, due to the acidic pH condition in the GM itself, resulting in about 0.5 unit of pH reduction if without the OM amendments.
The inoculation of soil microbes assists to generate microbial mediated OM decomposition and production of organic molecules exhibiting acidification effects, such as soluble carbohydrates and organic acids.
The organic amendment assists to bring about significant pH reduction in the red mud. The LH (C:N=18.0) amendment was more effective in pH neutralization than the SC (C:N=59.0).
The magnitude of pH reduction in the amended red mud increases with increasing the LH addition rate: 5% LH was moderately effective and 10% LH was highly effective in neutralizing the alkalinity and reducing the pH in the red mud.
The red mud exhibited a certain degree of pH buffering effects, with pH rise after the initial large pH decline on day 1. Without wishing to be bound by theory, this is thought to be caused by the continual dissolution of sodalite minerals ((NaAlSiO₄)⁶(Na₂X), where X can be SO₄²⁻, CO₃²⁻, Al(OH)⁴⁻ or Cl⁻) in the red mud.

### 4 Red Mud Bioremediation Experiment

The red mud bioremediation experiment was conducted over a 4-week period, including preparation. The treatment factors and protocols in this bioremediation experiment were refined, based on findings and logistic barriers identified in the preliminary experiment. This experiment aimed to:
compare effects of the types of organic amendments (i.e., soluble vs solid organic matter) on pH reduction, for identifying the promising options of bioneutralization for future trials;
identify potential microbial family/genus/species which are highly tolerant of alkaline and saline conditions in red mud, for bio-engineering the pH-neutralization system in the near future;
investigate chemical changes (e.g., organic acids and mineral elements) in the porewater of the amended red mud, in relation to microbial community structure and pH conditions in the amended red mud.

In this bioremediation experiment, both Caribbean Red Mud 1 and Caribbean Red Mud 2 were used, which were amended with four types of organic amendments, including solid organic matter (LH and SC) and soluble organics (molasses (MS) and glucose (GC)). All treatments were added with the basal amendments of 250 ml GM (100% v/w) and soil-microbial inoculum (see Table 6). The treatments were incubated under laboratory conditions, without continuous shaking as it did not alter the redox conditions in the red mud mixture. Changes of pH conditions were monitored and paste solution (or porewater) chemistry was analysed over the 14-d period as specified below.

The pH in the red mud samples were monitored by using Pocket pH Tester (Oakton Eco Testr 2). The treatments were subsampled for characterizing chemical properties and phylogenetic composition and structure of microbial communities in the red mud. The incubated red mud in each container was well mixed before subsampling for supernatant (paste solution or porewater) and sediment collection on day 1, 3, 5, 7 and 14. Approximate 30 g mixture were sampled and separated through centrifugation at 10000 g for 10 minutes into paste solution and solids. The supernatant were filtered through 0.45 μm glass fiber filter for the analysis of organic acids and total elements. DNA in the incubated red mud was extracted for phylogenetic analysis for microbial community composition and structure, in response to the treatment factors. At the end of incubation, the red mud samples were dried at 60° C. and powdered for general physical and biochemical properties analyses.

TABLE 6
Treatment details (organic amendments (OA)) in the red mud bioremediation
experiment incubated under laboratory conditions over a 14-d period.

| | Red Mud | | | | OA rate | Pre-incubation | Growth medium |
|---|---|---|---|---|---|---|---|
| ID No. | type | Treatment name | Red mud (g) | OA type | (g) | time (days) | (ml) |
| 1 | Caribbean | Caribbean Red Mud | 250 | NA | 0 | 0 | 250 |
| | Red Mud 1 | 1 + 100% GM | | | | | |
| 2 | Caribbean | Caribbean Red Mud | 250 | Lucerne hay (LH) | 25 | 18 | 250 |
| | Red Mud 1 | 1 + 10% LH + 100% GM | | | | | |
| 3 | Caribbean | Caribbean Red Mud | 250 | Sugarcane mulch (SC) | 25 | 18 | 250 |
| | Red Mud 1 | 1 + 10% SC + 100% GM | | | | | |
| 4 | Caribbean | Caribbean Red Mud | 250 | Molasses(MS) | 2.5 | 1 | 250 |
| | Red Mud 1 | 1 + 1% MS + 100% GM | | | | | |
| 5 | Caribbean | Caribbean Red Mud | 250 | Glucose(GC) | 2.5 | 1 | 250 |
| | Red Mud 1 | 1 + 1% GC + 100% GM | | | | | |
| 6 | Caribbean | Caribbean Red Mud | 250 | NA | 0 | 0 | 250 |
| | Red Mud 2 | 2 + 100% GM | | | | | |
| 7 | Caribbean | Caribbean Red Mud | 250 | Lucerne hay (LH) | 25 | 18 | 250 |
| | Red Mud 2 | 2 + 10% LH + 100% GM | | | | | |
| 8 | Caribbean | Caribbean Red Mud | 250 | Sugarcane mulch (SC) | 25 | 18 | 250 |
| | Red Mud 2 | 2 + 10% SC + 100% GM | | | | | |
| 9 | Caribbean | Caribbean Red Mud | 250 | Molasses(MS) | 2.5 | 1 | 250 |
| | Red Mud 2 | 2 + 1% MS + 100% GM | | | | | |
| 10 | Caribbean | Caribbean Red Mud | 250 | Glucose(GC) | 2.5 | 1 | 250 |
| | Red Mud 2 | 2 + 1% GC + 100% GM | | | | | |

Note:
Each treatment with three replicates and a total of 30 containers.

Physicochemical, Biochemical and Phylogenetic Analysis

Mineralogical Analysis

The mineralogy of the two sources of red mud was analysed by ALS and the data were provided by the contractor. Red mud mineralogy was determined by X-ray diffractometry (XRD). Selected samples were prepared for scanning electron microscopy (SEM) and energy dispersive X-ray spectrometry (EDS) to investigate micromorphology.

Properties of Organic Matter

Total organic carbon (TOC) and N (TN) concentrations in the organic matter (OM) used (LH and SC) were determined by means of dry-combustion with a LECO CNS-2000 analyser (LECO Corporation, MI, USA). Soluble sugars in the OM were extracted with 80% hot ethanol (80° C.) and filtered through 0.45 μm glass-fibre filter, which were quantified by using phenol-sulphuric acid method and calculated as glucose equivalent. Starch in the OM was hydrolysed into soluble sugars, with 0.01 M sulfuric acid in a water bath for 2 hours at 95° C. The starch content was estimated by multiplying the glucose-equivalent content by a factor of 0.9.

Physicochemical and Biochemical Analysis

The pH of the treatment samples were measured by using Pocket pH Tester (Oakton Eco Testr 2). Cation exchange capacity (CEC) was quantified using the silver thiourea method. Concentrations of elements in paste solution (or porewater) were analysed by means of ICP-OES after acidification with nitric acid. The low molecular weight organic acids were analysed in the filtered paste solution (being acidified prior to analysis) by using a high-performance liquid chromatography (HPLC) with absorbance detection.

Phylogenetic Analysis of Microbial Community Composition and Structure

DNA extraction in the red mud samples was performed with a PowerSoil® DNA Isolation Kit (MO BIO LACoratories, Inc.). DNA concentration and quality were verified with a Nanodrop spectrometer (Thermo Scientific, US). Only quality DNA was selected and submitted to the Australian Centre for Ecogenomics (The University of Queensland) for pyrosequencing with paired-end Illumina MiSeq platform. Universal fusion primers 926F (5′-AAACTYAAAKGAATTGACGG-3′) and 1392wR (5′-ACGGGCGGTGWGTRC-3′) were applied, which are supposed to cover most bacteria, archaea and eukaryotes. All FASTQ files were processed with FASTQC. The first 20 bases of all FASTQ files were trimmed to remove primer sequence, and further quality-trimmed to remove poor quality sequence using a sliding window of 4 bases with an average base quality above 15 by using the software Trimmomatic. All reads were then hard-trimmed into 250 bases and any with less than 250 bases were excluded. FASTQ files were then converted to FASTA files. Assembled sequences along with the corresponding quality values were processed using the Quantitative Insights Into Microbial Ecology (QIIME) toolkit. Sequences with 97% similarity were classified into an operational taxonomic unit (OTU) and taxonomy assignment and alignment features suppressed. The resulting OTU table is filtered to remove any OTU with an abundance of less than 0.05%. Representative OTU sequences are then BLASTed against the reference database (Greengenes version 2013/05 for 16S, Silva version 119 for LSU, and UNITE singleton included release Apr. 7, 2014 for fungal ITS amplicons). The rarefaction curve and the non-normalized OTUs table, with the abundance of different OTUs and their taxonomic assignments for each sample were generated in QIIME. Mean number of OTUs and alpha diversity values based on the non-normalized OTU table were calculated in R (package ‘vegan’). Nomalizer (Imelfort and Dennis, 2011) was used to find a centroid normalized OTUs table. A heatmap (version 2.15.1; package ‘heatmap2’) were created in R (Kolde, 2012).

Data Analysis

One-way analysis of variance (ANOVA) was carried out for significant tests among treatments. Means were compared using the least significant differences (LSD) test at P=0.05. All statistical analyses were conducted using the SPSS software package (SPSS Statistics 23.0, Chicago, Ill., USA).

Results and Discussion

Physicochemical and Mineralogical Properties of Red Mud

In general, primary mineralogical and chemical properties for these experiments were similar in the Caribbean Red Mud 1 and Caribbean Red Mud 2, including pH (10.5, 10.6, respectively) and Fe-oxide content (about 40%) (see Table 7). The levels of total As, Pb and Zn in the Caribbean Red Mud 2 were a bit higher than in the Caribbean Red Mud 1, though they were in the same order of magnitude. The Caribbean Red Mud 2 also contained much higher proportions of Al₂O₃ (20%), compared to that in the Caribbean Red Mud 1 (13.2%) (see Table 7).

TABLE 7
Selective properties of Caribbean Red Mud 1 and
Caribbean Red Mud 2 red mud. The values were
means with standard deviation in the parentheses.

| Red mud | | Major minerals (%) | | | |
|---|---|---|---|---|---|
| type | pH_{1:5H2O} | Al₂O₃ | Fe₂O₃ | CaO | |
| Caribbean | 10.5(0.1) | 13.3(0.8) | 40.0(0.9) | 13.8(0.5) | |
| Red Mud 1 | | | | | |
| Caribbean | 10.6(0.1) | 20.0(0.7) | 40.7(1.0) | 5.3(0.4) | |
| Red Mud 2 | | | | | |
| | Metal(loid) contents (ppm) | | | | |
| | Cu | Pb | Zn | Ba | As |
| Caribbean | 104(5) | 159(4) | 318(22) | 139(4) | 87(4) |
| Red Mud 1 | | | | | |
| Caribbean | 89(6) | 173(8) | 366(44) | 124(6) | 110(6) |
| Red Mud 2 | | | | | |

Note:
Mineral composition and major elements concentrations are average of 10 samples from each red mud dams.

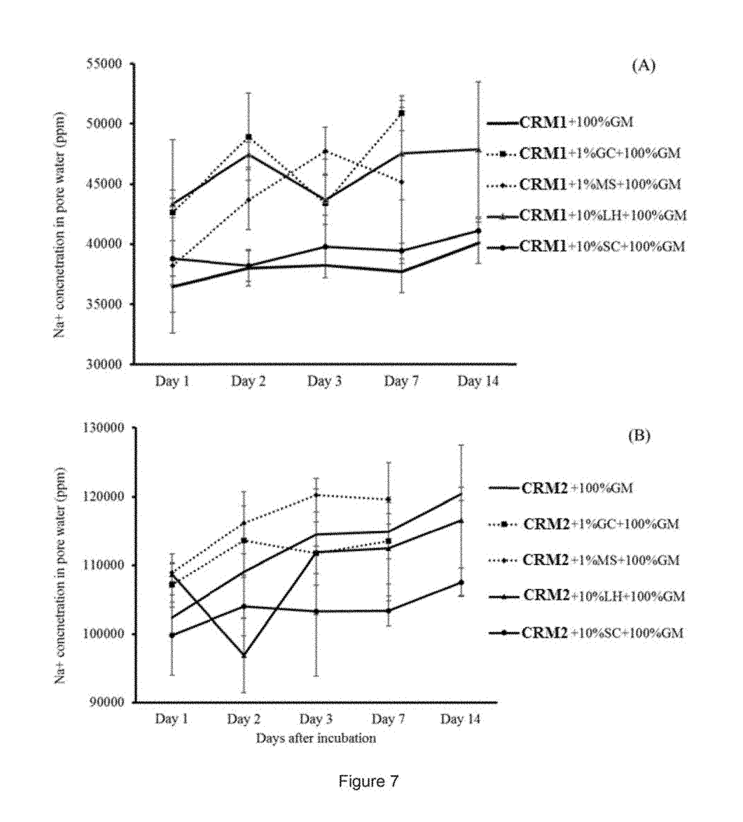

The biggest difference between the two sources of red mud was the level of soluble Na in the red mud. On the basis of soluble Na in the incubated red mud without organic matter addition, Caribbean Red Mud 2 contained much higher soluble Na (10.2%) concentration than the Caribbean Red Mud 1 (3.8%) (FIG. 7). This was probably because the Caribbean Red Mud 2 was freshly deposited at the time of collection.

Microbial Properties of Red Mud in Comparison with Garden Soil

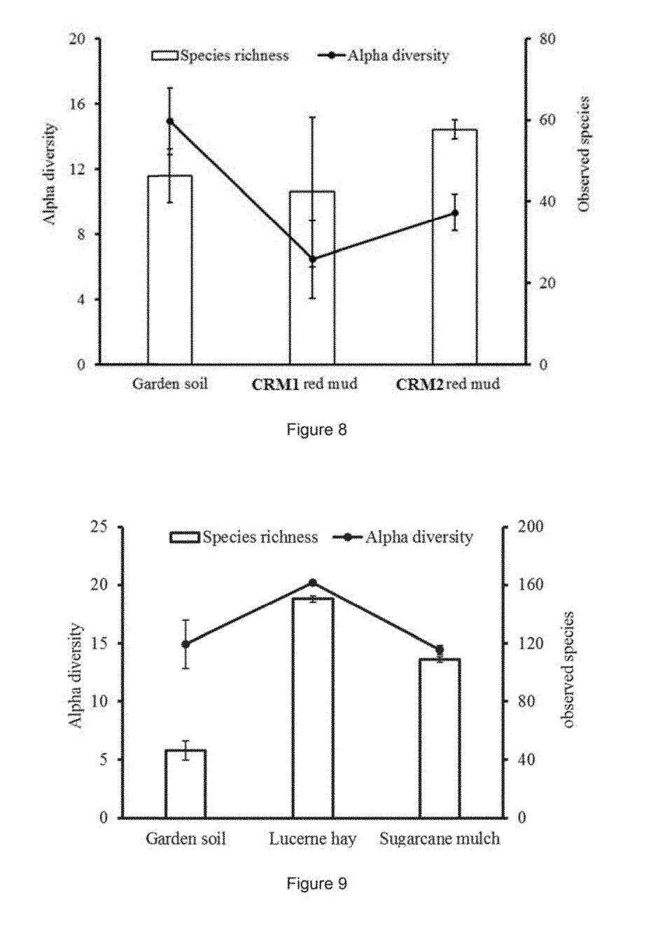

During the storage, transport and handling, some microbes may have colonized in the red mud, though the number of species was small (about 60) (FIG. 8). The microbial species diversity (alpha diversity) in the red mud was lower (P <0.05) than the garden soil (FIG. 8). The red mud contained little fungi (<0.1%), compared to the garden soil which was rich in fungi (6%).

Gammaproteobacteria (42-53%), Bacteroidetes (19-24%) and Firmicutes (12-22%) were the top three most abundant groups in the red mud and garden soil. However, compared to the red mud, aerobatic bacteria were more abundant in garden soil, such as Flavobacterium sp. In addition, garden soil also contained abundant Aspergillus spp. (associated with plant roots), fungi (a dagger nematode, Arthrobacter sp.).

Alkalibacterium spp., which are bacteria highly tolerant of alkaline conditions were abundantly present in the red mud without any amendment. The bacteria were also present in high abundance in the garden soil used to produce microbial inoculum. Other bacterial genus including Porphyromonas sp., Citrobacter sp., Tannerella sp., Burkholderia sp., Propionibacterium sp., and Enterococcus sp. were abundant in the red mud but not the soil.

Microbial Communities in Organic Matter Incubated with Soil Inoculum

The organic matter (lucerne hay (LH) and sugarcane mulch (SC)) samples were incubated with the soil inoculum to evaluate the possibility to build up microbial abundance prior to the addition into the red mud. Species richness and diversity in the preincubated LH and SC increased significantly from 46 to 150 and 109 respectively (P<0.05), compared to the garden soil itself. The richness and diversity in the LH were significantly higher than the SC (P<0.05). (FIG. 9). This may be due to the higher N content in the LH, compared to the SC.

The major phyla in the preincubated LH were composed of Actinobacteria (42%), Gammaproteobacteria (19.8%) and Bacteroidetes (12.7%). The abundance of Actinobacteria, Firmicutes and other eukaryote increased significantly in the incubated LH (P<0.05). In comparison, the most abundant phylum and classes in the preincubated SC were Bacteroidetes (30.1%), Gammaproteobacteria (21.8%) and fungi (20.1%). Fungi and Alphaproteobacteria increased significantly in the incubated SC (P<0.05). The pre-incubation with soil inoculum stimulated the abundance of dominant species in the lucerne hay, particularly aerobic bacteria which are related to organic matter decomposition (e.g., Nocardiopsis spp., lysobacter spp., Sphingobacterium sp. and Alcaligenes spp.). In contrast, a few species commonly found to be associated with plant roots (e.g., Aspergillus sp. and Streptomyces sp.) were stimulated in preincubated sugarcane.
Tolerant species were abundantly present in all three habitats—garden soil, organic matter and red mud: including, species tolerant of salt (e.g., Enterococcus spp. and Amoebophrya spp.) and alkalinity (e.g., Alkalibacterium spp., Oceanobacillus sp., Xanthomonas spp.)
The pre-incubation with soil inoculum stimulated the abundance of dominant species in the Lucerne hay, particularly aerobic bacteria which are related to organic matter decomposition and would have played a critical role in the bioneutralization of the alkaline conditions in the red mud.
Some species commonly associated with plant roots (e.g., Aspergillus spp. and Streptomyces spp.) were stimulated in the preincubated SC.

Bioremediation Experiment with Both Caribbean Red Mud 1 and Caribbean Red Mud 2.

This experiment was built on the findings of the preliminary experiment and included both the Caribbean Red Mud 1 (older) and Caribbean Red Mud 2 (new) red mud, in which the latter contained much higher levels of soluble Na in its paste solution.

In addition, the LH and SC organic matter (10% w/w) was preincubated with soil inoculum for about 18 days before being added into the red mud, which were the same batch of preincubated organic matter as those in the preliminary experiment. This was to maintain the consistency of microbial inoculum effects, but the LH and SC were more decomposed at the time of red mud addition, compared to the preliminary experiment. It was also considered to generate more soluble organic acids or carbohydrates in the organic matter for achieving stronger effects of pH reduction in the red mud.

The soluble sources of organic matter (i.e., molasses (MS) and glucose (GC) (as a substitution of Dunder) were also included in the experiment. Soluble MS and GC was inoculated with the same soil inoculum and preincubated for 24 hours, rather than 18 days as the solid OM (LH and SC).

Effects of Solid Organic Amendments

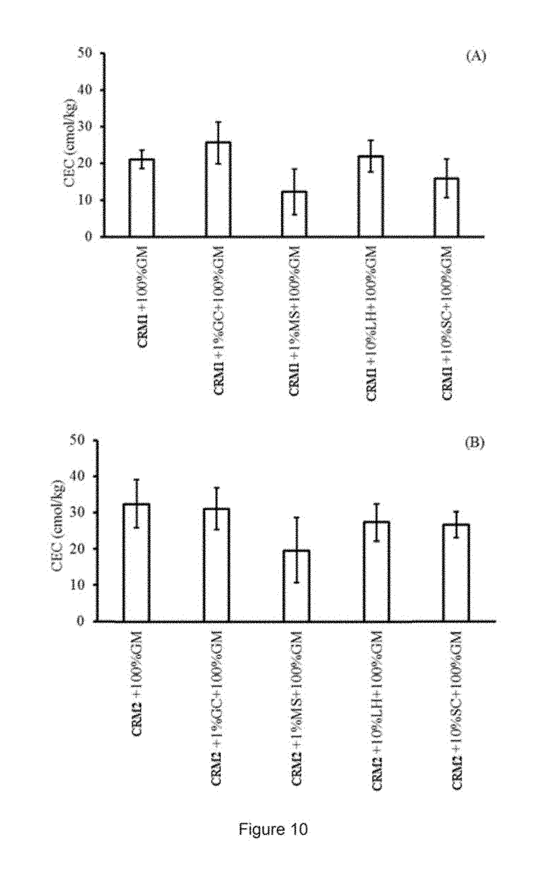

The effects of organic amendments on the CEC of the red mud (Caribbean Red Mud 1 and Caribbean Red Mud 2) were not consistent even after 14 days of incubation, which were within the range of 10-30 cmol/kg and 10-40 cmol/kg for Caribbean Red Mud 1 and Caribbean Red Mud 2 respectively (FIG. 10).

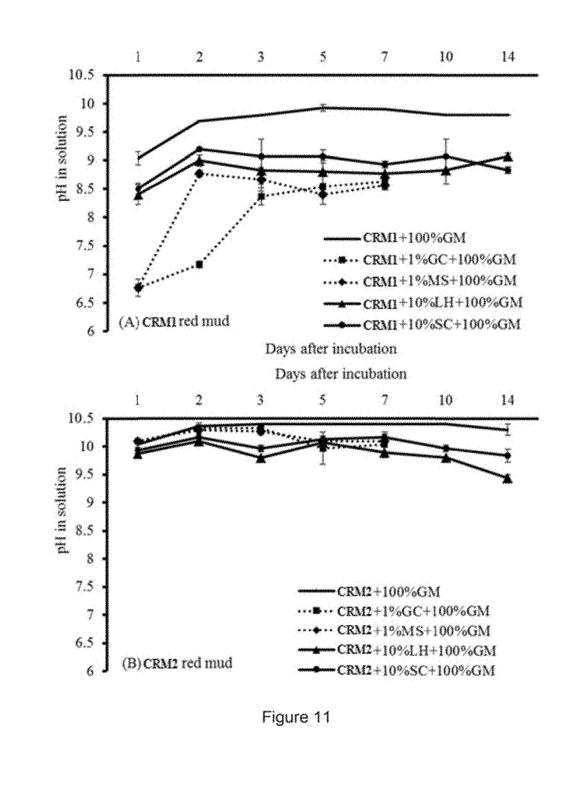

It was found that both LH and SC amendments resulted in significant pH reduction, but the pH reduction was much larger in the Caribbean Red Mud 1 than the Caribbean Red Mud 2 (FIG. 11). For example, at Day 1, pH in the LH and SC amended Caribbean Red Mud 1 decreased by 2-4 units and Caribbean Red Mud 2 by 0.5-1 unit. Due to the pH buffering effects of the red mud, the pH increased 0.5-0.7 units in the LH and SC amended Caribbean Red Mud 1 on day 2 and became stable at 8-9 until day 14.

Comparatively, pH values in amended Caribbean Red Mud 2 fluctuated in the 1st week (day 1-7), but gradually declined in the 2nd week of the incubation experiment (FIG. 11). The final pH in organic amended Caribbean Red Mud 2 declined only by 0.5-1 unit in 14 days, reaching a pH of 9.5-10, but with a declining trend by the end of the experiment. Further pH reduction in the amended Caribbean Red Mud 2 was not attained beyond the 14-day period.

Effects of Soluble Organic Matter on pH Reduction

The amendments of molasses and glucose produced a dramatic pH reduction in the Caribbean Red Mud 1 (but not Caribbean Red Mud 2) on day 1, reaching as low as 6.5-7.0 (FIG. 11). However, the pH value rapidly recovered to 8.7 for the MS on day 2 and 8.3 for the GC on day 3. The pH conditions in the MS and GC treatments were stabilized at about 8.6 until day 7 when the trial was terminated because of no further pH reduction.

In contrast, the MS and GC treatments did not produce significant effects on pH, compared to the Caribbean Red Mud 2 with only the growth medium added (FIG. 11(B))

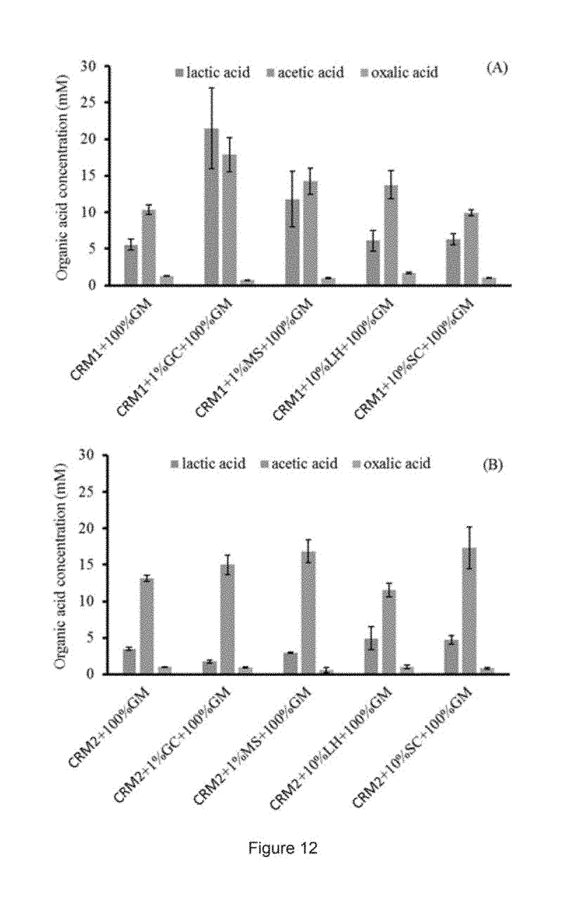

It was unclear if the MS and GC in the treatments reached depletion status (unlike the solid OM—LH and SC). However, the largest pH reduction in the Caribbean Red Mud 1 treatments (despite the quick pH recovery after day 1) coincided with their highest levels of LMW organic compounds (e.g., lactic acid and acetic acid) (FIG. 12).

Low Molecular Weight Organic Compounds in the Amended Red Mud

The soluble LMW organic compounds were only analyzed on day 1, when the levels were supposed to be the most abundant (coinciding with the largest pH reduction on day 1). The detectable organic acids (which were actually present in their salt forms and converted into acid forms after acidification) were mainly lactic acid, acetic acid and oxalic acid. The presence of high levels of lactic and acetic acids in the paste solution of treated red mud was consistent with the fermentation reactions under anaerobic conditions (FIG. 4);

For the Caribbean Red Mud 1, the levels of lactic acid and acetic acid in the 1%

GC treatment were highest, followed by the 1% MS treatment. In these two soluble organic amendments, the levels of both acids were similar, unlike the solid organic matter treatments (e.g., LH and SC).

In the LH and SC treatments, the level of acetic acid was much higher than that of lactic acid. The organic acid levels in the SC treatment were lower than those in the GC, MS and LH treatments;

For the Caribbean Red Mud 2, the pattern of organic acid levels in the treatments appeared to be different from the Caribbean Red Mud 1. The organic acids were mainly acetic acid, which were similar across all treatments. The levels of lactic acid in the paste solution were much lower than the acetic acid, which were lower than those in the Caribbean Red Mud 1 treatments. The Caribbean Red Mud 2 was much more sodic than the Caribbean Red Mud 1, which might suppress microbial abundance and activities, resulting lower production of organic acids;

Although the results were only from the samples on day 1, it suggests that the Caribbean Red Mud 1 and Caribbean Red Mud 2 treatments may have different microbial communities and fermentation process. The presence of organic acids in the paste solution is not only the result of organic matter decomposition catalyzed by bacteria, but the neutralization reactions.

Microbial Community Composition and Structure in the Organic Amended Red Mud

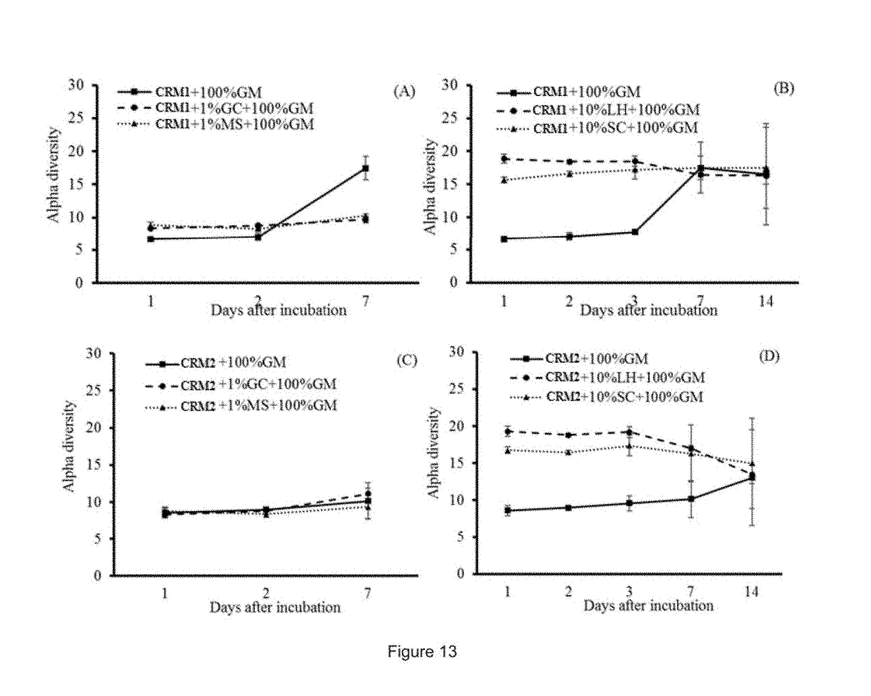

Microbial species diversity in the red mud appeared in two contrasting trends between the treatments of soluble organics (i.e., MS and GC) and solid organic matter (i.e., LH and SC) (FIG. 13). The MS and GC treatments did not increase species diversity in both Caribbean Red Mud 1 and Caribbean Red Mud 2. The species diversity in the LH and SC treatments was almost tripled in the Caribbean Red Mud 1 (FIG. 13 (B)) or doubled in the Caribbean Red Mud 2 (FIG. 13 (D)) in the first 3 days (at least). However, species diversity in the LH and SC treatments converged with the red mud with only GM from day 7 onwards, perhaps due to the growth cycles of microbes in the close incubation system.

The species diversity changes over time in the LH and SC treatments suggest that is necessary to monitor the dynamic changes of tolerant microbes in the amended red mud and identify conditions favouring the persistence of functional microbes which can tolerate the geochemical and chemical conditions in the system while maintaining high functions in organic matter decomposition and organic acid production.

Phylogenetic Composition of Microbial Community in Amended Red Mud

Dynamics of microbial community composition at phylum and/or class level in organic amended red mud:
For Caribbean Red Mud 1:
   Soluble organic amendments (e.g., molasses and glucose) didn't alter the microbial community composition and relative dominance of the phyla, which was dominated by Gammaproteobacteria (82.1-82.6%) and Firmicutes (17.3-17.9%).
   In contrast, the solid organic matter (LH, SC) amendments changed the microbial community composition. The most abundant phyla and/or classes in the LH amended Caribbean Red Mud 1 were Gammaproteobacteria (37.3%), Actinobacteria (19.0%), Betaproteobacteria (18.3%) and Bacteroidetes (16.5%). The most abundant phylums and/or classes in the SC amended Caribbean Red Mud 1 were Gammaproteobacteria (72.5%), Firmicutes (5.9%), Fungi (5.7%) and Actinobacteria (5.0%);
   The phyla and/or classes in the LH amended red mud were distributed more even than those in the SC treatment.
For Caribbean Red Mud 2:
   Soluble organic amendments (e.g., molasses and glucose) did not change the community composition, but increased the relative dominance of Gammaproteobacteria from 69.3% to 91.9-93.7%, compared to the red mud in the growth medium only;
   The most abundant phyla and/or classes in the LH amended red mud were Gammaproteobacteria (36.6%), Actinobacteria (30.4%), Betaproteobacteria (12.2%) and Bacteroidetes (12.1%). The most abundant phyla and/or classes in the SC amended red mud were Gammaproteobacteria (62.2%), Firmicutes (6.7%), Fungi (8.8%), Actinobacteria (7.6%) and Bacteroidetes (6.7%);
   The phyla and/or classes in the LH amended red mud were distributed more even than those in the SC treatment.

Interestingly, the abundance of fungi was significantly increased in the LH and SC amended red mud (both for Caribbean Red Mud 1 and Caribbean Red Mud 2). The soluble organic treatments did not alter phylogenetic composition of microbial communities in the red mud. As a result, on the basis of phylogenetic composition of microbial community in the amended red mud, the soluble organic amendments (i.e., MS, GC) were clearly differentiated from the solid organic matter (i.e., LH and SC) amended treatments.

The phylogenetic composition in the LH and SC amended red mud appeared to be dynamically changing over time, with increased relative abundance of Firm icutes and fungi over time and decreased abundance of Gammaproteobacteria. This effect on the relative abundance appeared to be stronger in the LH than the SC;

Dynamics of Dominant Genus in Microbial Communities Affected By the Organic Amendments
In the soluble organic (MS, GC) amendments, bacteria catalyzing OM-degradation, Enterrobacter sp. and biofilm-forming bacteria, Serratia sp. were dominant species in the microbial communities, which were in contrast to the LH and SC treatments;
The LH amendment stimulated the relative abundance of bacteria associated with organic matter decomposition (e.g., Lysobacter sp., Flavobacterium sp. and Nocardiopsis sp.) and tolerant bacteria (Alkalibacterium sp., and Enterobacter sp.) and fungi (e.g., Arthrobacter sp. in Caribbean Red Mud 1 red mud);
In the SC amended red mud, abundant species included bacteria associated with organic matter decomposition (e.g., Flavobacterium sp.), tolerant bacteria (e.g., Pseudohongiella sp. and Stenotrophomonas sp.) and bacteria associated with plant roots (e.g., Streptomyces sp., and Aspergillus sp.).

Conclusions

The pH reduction in organic matter amended red mud was caused by the production of organic acids (e.g., lactic acid and acetic acid) from the decomposition of the added organic matter, which reacted with alkaline ligands in the red mud. Although the results on the organic acids were limited, their presence was consistent with fermentation processes under anoxic conditions in the bio-reaction system and the presence of dominant microbes. The highest levels of lactic and acetic acids were detected on Day 1 in the treatment of soluble organics (MS, GC), which coincided with the largest pH reduction on the same day. In contrast, the LH and SC amendments seemed to generate longer-lasting neutralizing effects, but at lower intensity.

The amendments with soluble organics (MS, GC) and biomass organic matter (LH, SC) significantly lowered the pH by 1.5-3.0 units in the Caribbean Red Mud 1 and 0.5-1.0 unit in the Caribbean Red Mud 2 after 5-14 days of incubation. The soluble organics (MS and GC) generated largest amount of acetic acids on day 1, coinciding with resultant pH reduction, but this effect did not persist afterwards, while the solid organic matter seemed to generate longer effects of neutralization over time. The usefulness of growth medium in the bioremediation system may be short-lived and limited, if solid organic matter (e.g., LH and SC) is used in the remediation.

In the shorter-term preliminary experiment (up to 7 days) under anoxic conditions (solid:solution=1:1), the pH in Caribbean Red Mud 1 were lowered to about 8.0 in 5-7 days of treatment with 10% (w/w) Lucerne hay (LH) (preincubated with soil inoculum for 24 hours before use), but only to 9.0 with 5% LH. The sugarcane mulch (10% w/w) was less effective than the LH in lowering the pH of red mud, resulting in a pH reduction from about 10.5 to about 9.0 in 7 days in the amended Caribbean Red Mud 1. In the subsequent 14-d experiment, the effectiveness of SC and LH (preincubated for 18 days with soil inoculum before use) appeared similar in the Caribbean Red Mud 1, lowering the pH in paste solution (or porewater) to around 9.0. In contrast, in the more sodic Caribbean Red Mud 2, the SC and LH amendments only resulted in 0.5-1.0 unit of pH reduction, with solution pH 10 and 9.5 on day 14, respectively. Without wishing to be bound by theory, the differences in the effectiveness of pH neutralization between the shorter-term (5-7 days) and the longer-term (14 days) experiments is thought to be caused by (1) the depletion of organic acids/molecules in the SC and LH preincubated for 18 days due to microbial respiration and C-consumption, (2) depletion/imbalance of some growth factors and (3) associated microbial community composition and dominance of functional microbes for organic acid production.

A strong pH buffering behaviour was exhibited in the red mud, in response to the treatments, due to the presence of high alkalinity in the solution, which can be pre-existing (e.g., in the case of Caribbean Red Mud 2) and continuously replenished from the dissolution of sodalite in the red mud (e.g., in the case of both Caribbean Red Mud 1 and Caribbean Red Mud 2). This was suggested by the rapid pH recovery in the Caribbean Red Mud 1 after day 1 and small pH reduction in response to the organic matter amendments for 14 days. The red mud samples from Alpart (Caribbean Red Mud 1) and Jamalco (Caribbean Red Mud 2) dams were rich in clay minerals (Al/Fe oxides) and of high salinity, sodicity and alkalinity, with pH around 10.5. However, the Caribbean Red Mud 2 red mud contained much higher levels of soluble Na (10.2% in paste solution), which may be one of the factors contributing to the stronger pH buffering capacity than Caribbean Red Mud 1, and total metal(loid)s (e.g., As, Pb, and Zn) and higher proportions of Al-oxides, than the Caribbean Red Mud 1 (3.8% soluble Na in paste solution).

Despite the unfavourable conditions in the red mud, many groups of bacteria were detected but low in abundance, such as Alkalibacterium, Enterobacter and Klebsiella. However, the diversity and abundance of bacteria and fungi catalysing organic matter decomposition were not present in the red mud, unless amended with the LH or SC (carrying natural microbes) and inoculated with soil microbes.

Microbial community in both Caribbean Red Mud 1 and Caribbean Red Mud 2 are highly dominated by Gammaproteobacteria and tolerant species, which were not significantly changed in red mud amended with soluble organic amendments (e.g., molasses and glucose in this study).

The composition and properties of solid organic matter (LH and SC) used in the red mud amendments significantly alter the diversity, abundance and dominance of microbes in the bioreaction system. Lucerne hay and sugarcane mulch amendments increased species diversity, richness and evenness in the amended red mud, especially in the former during the first 3 days (for both Caribbean Red Mud 1 and Caribbean Red Mud 2). Without wishing to be bound by theory, the inventor is of the view that this is related to the biochemical properties of the LH (e.g., C:N ratio). The abundance of fungi and root-associated bacteria were significantly increased in the SC-amended red mud (for both Caribbean Red Mud 1 and Caribbean Red Mud 2).

The composition and properties of organic matter used in the amendments of red mud significantly alter the diversity, abundance and dominance of microbes in the bioreaction system. The addition of soluble organics (i.e., glucose (in lieu of Dunder), molasses) did not alter the microbial community structure and composition in the red mud, but strongly increase the abundance of Gammaproteobacteria. In contrast, the SC and LH amendments increased the relative abundance of Firmicutes, Actinobacteria, bacteroidetes, and fungi. In the red mud amended with the soluble organics (MS, GC), bacteria catalyzing OM-degradation, Enterrobacter sp. and biofilm-forming bacteria, Serratia sp. were dominant species in the microbial communities. In the SC and LH amended red mud, abundant species included organic matter decomposing bacteria (e.g., Lysobacter sp., Flavobacterium sp., Nocardiopsis sp.), tolerant bacteria (e.g., Alkalibacterium sp., Enterobacter sp., Pseudohongiella sp., and Stenotrophomonas sp.), bacteria associated with plant roots (e.g., Streptomyces sp., Aspergillus sp.), and fungi.

In the LH and SC amended red mud, the abundance of Betaprobacteria,

Firmicutes and Actinobacteria increased and the abundance of tolerant (pathogenic) Gammaproteobacteria declined with the time course of incubation. However, these did not appear in the red mud amended with soluble organics.

In view of the above, the experiments have shown that bio-neutralization via microbial mediated organic matter decomposition effectively lowered the pH in the red mud, but the magnitude of pH reduction varied with the mineralogy and geochemistry of red mud, organic matter composition and properties, and the composition and functions of colonizing microbial communities in the bio-reaction system. The bioreaction system appeared to be anoxic and fermentation processes seemed to prevail.

The decomposition of organic matter is largely dependent on recolonizing organotrophic bacteria tolerant of alkalinity and salinity which decompose organic matter into organic acids and molecules with functional ligands, rather than lithotrophic bacteria using inorganic substrate (such as those in the fresh red mud without nutrients and organic carbon, mainly spore-forming Bacillus and non-spore forming

Lactobacillus).

Overall, key factors affecting the bioneutralization effects of organic amendments may include (1) organic matter composition and properties, (2) abundance of functional microbes in soil inoculum and the amended red mud which are tolerant of high alkalinity and salinity, low oxygen and functional in organic acid production, and (3) the mineralogy and geochemistry of the red mud concerned.

It will be understood that the invention disclosed and defined in this specification extends to all alternative combinations of two or more of the individual features mentioned or evident from the text or drawings. All of these different combinations constitute various alternative aspects of the invention.

1. A process for the bio-neutralisation of red mud, the process including:
feeding an alkaline red mud into a bio-digester;
feeding biomass including insoluble organic matter into the bio-digester, the biomass supporting a microbial consortium;
mediating the digestion of the biomass in the bio-digester or through a train of bio-digesters with microbes in the microbial consortium, to thereby produce organic acid(s) which neutralise alkalinity of the red mud and reduce pH of the red mud;
producing a bio-neutralised red mud product having a pH of 10 or less.

2. The process of claim 1, wherein the biomass is fed into the bio-digester in an amount that is at least about 5 w/w % of the dry red mud.

3. The process of claim 2, wherein the biomass is fed into the bio-digester in an amount that is at least about 7 w/w % of the dry red mud.

4. The process of claim 1, wherein the insoluble organic matter is plant-based organic matter.

5. The process of claim 4, wherein the plant-based organic matter includes Lucerne hay, sugar cane, bagasse, citrus pulp, coffee husks.

6. The process of claim 1, wherein prior to the step of feeding the biomass into the bio-digester, the method further includes:
incubating the biomass for an incubation time with a soil inoculum including a foreign microbial population.

7. The process of claim 6, wherein the incubation time is less than about 18 days.

8. The process of claim 7, wherein the incubation time is less than about 5 days.

9. The process of claim 1, wherein the organic acids include at least one of lactic acid and acetic acid.

10. The process of claim 1, wherein the process additionally includes providing a nutrient amendment to the red mud and/or microbial consortium.

11. The process of claim 10, wherein the nutrient amendment includes the addition of dunder.

12. The process of claim 10, wherein the nutrient amendment includes the addition of gypsum.

13. The process of claim 1, wherein the process is a continuous process, and wherein
the step of feeding the alkaline red mud into the bio-digester is a step of continuously feeding the alkaline red mud into the bio-digester;
the step of feeding biomass into the bio-digester is a step of continuously feeding the biomass into the bio-digester; and
the process further includes continuously withdrawing the neutralised red mud product from the bio-digester or the train of bio-digesters.

14. The process of claim 13, wherein the bio-digester or train of bio-digesters is a flow through cell bio-digester or a train of flow through cell bio-digesters.

15. The process of claim 14, wherein the flow through cell bio-digester or train of flow through cell bio-digesters is operated to have a residence time of from about 12 to 20 days.

16. The process of claim 13, wherein the bio-digester or train of bio-digesters is a stirred tank bio-digester or a train of stirred tank bio-digesters.

17. The process of claim 16, wherein the a stirred tank bio-digester or a train of stirred tank bio-digesters is operated to have a residence time of from about 5 to 10 days.

18. The process of claim 1, wherein the bio-neutralised red mud product has a pH that is 9 or less

19. The process of claim 18, wherein the bio-neutralised red mud product has a pH in the range of from about 7 to about 8.
